(19) United States
(12) Patent Application Publication
(10) Pub. No.: US 2010/0256920 A1
(43) Pub. Date: Oct. 7, 2010

(54) Apparatus for quantifying concentration, method for quantifying concentration, and program for quantifying concentration

(75) Inventors: Kazuhiko Amano, Tokyo - to (JP); Koichi Shimizu, Sapporo-shi (JP)

Correspondence Address: OLIFF & BERRIDGE, P.O. BOX 19928, ALEXANDRIA, VA, 22320, US

(73) Assignees: SEIKO EPSON CORPORATION, TOKYO (JP); NATIONAL UNIVERSITY CORPORATION HOKKAIDO UNIVERSITY, SAPPORO-SHI (JP)

(21) Appl. No.: 12/659,932

(22) Filed: Mar. 25, 2010

(30) Foreign Application Priority Data
Mar. 31, 2009 (JP) P2009-087454

(51) Int. Cl. G06F 19/00; G01N 21/47

(52) U.S. Cl. 702/23; 356/342

(57) ABSTRACT

An apparatus for quantifying concentration includes a temporal path-length distribution (TPD) storage unit configured to store a TPD model of a short-time-pulse of light, a time-resolved waveform storage unit configured to store a time-resolved waveform model of the short-time-pulse of light, a light irradiating unit configured to irradiate the short-time-pulse of light, a light receiving unit configured to receive a backscattered light, a measured light intensity acquisition unit configured to acquire a light intensity of the backscattered light, a TPD acquisition unit configured to acquire a TPD, a model light intensity acquisition unit configured to acquire the light intensity of the short-time-pulse of light, a light absorption coefficient calculating unit configured to calculate a light absorption coefficient, and a concentration calculating unit configured to calculate the concentration of a target component.

### BACKGROUND

1. Technical Field

The present invention relates to an apparatus, a method, and a program for quantifying concentration, which quantify a concentration of a target component in an arbitrary target layer, which is in an observed object formed of a plurality of layers of light scattering medium.

Priority is claimed on Japanese Patent Application No. 2009-087454, filed Mar. 31, 2009, the content of which is incorporated herein by reference.

2. Related Art

In the past, blood sugar level was measured by collecting blood from, for example, a person's fingertip and measuring enzyme activity of glucose in the blood. In this method of measuring the blood sugar level, it is necessary to collect blood from a fingertip or the like and analyze the blood. The collection of blood causes labor and pain. The collection of blood requires a measurement chip on which to put the blood. Therefore, a non-invasive method of measuring blood sugar level, without collecting blood, is required.

A method of determining a concentration of glucose by irradiating a near-infrared light to a skin and calculating the concentration of glucose from a light absorption amount is examined (See Japanese Unexamined Patent Application, First Publication No. 2003-144421, for example). Specifically, a standard curve, which shows a relationship between the concentration of glucose, a wavelength of the irradiated light, and the light absorption amount, is prepared beforehand. An area of a certain wavelength is scanned by a micrometer or the like. The light absorption amount in the area is acquired corresponding to each wavelength. The concentration of glucose is determined by comparing the wavelength, the absorption amount, and the standard curve.

In the non-invasive method of measuring the blood sugar level described above, a near-infrared spectrum in a dermis layer is acquired by determining the distance between a position where the light is input and a position where the light is output. Therefore, the acquired spectrum includes a spectrum in the dermis layer, a spectrum in an epidermis layer, and a spectrum in a hypodermis layer. The observed alternation of an absorption coefficient is affected by a noise based on the epidermis layer and the hypodermis layer.

### SUMMARY

The invention provides an apparatus, a method, and a program for quantifying the concentration of a target layer while suppressing the noise effect from the other layers.

An apparatus for quantifying concentration, which quantifies the concentration of a target component in an arbitrary target layer, which is in an observed object formed of a plurality of layers of light scattering medium, may include a temporal path-length distribution of light (TPD) storage unit configured to store a TPD model for a short-time-pulse of light, which is irradiated to the observed object, with plurality of layers of light scattering medium, a time-resolved waveform storage unit configured to store a time-resolved waveform model of the short-time-pulse of light, which is irradiated to the observed object, a light irradiating unit configured to irradiate the short-time-pulse of light to the observed object, a light receiving unit configured to receive a backscattered light, the short-time-pulse of light being backscattered from the observed object, a measured light intensity acquisition unit configured to acquire a light intensity of the backscattered light, which has been received by the light receiving unit at a predetermined time after the light irradiating unit had irradiated the short-time-pulse of light, a TPD acquisition unit configured to acquire the TPD of each layer of the plurality of layers of light scattering medium at the predetermined time from the TPD model in the TPD storage unit, a model light intensity acquisition unit configured to acquire the light intensity of the short-time-pulse of light at the predetermined time from the time-resolved waveform model of the short-time-pulse of light in the time-resolved waveform storage unit, a light absorption coefficient calculating unit configured to calculate a light absorption coefficient of the arbitrary target layer, based on the light intensity, which has been acquired by the measured light intensity acquisition unit, the TPD of each layer of the plurality of layers of light scattering medium, which has been acquired by the TPD acquisition unit, and the light intensity, which has been acquired by the model light intensity acquisition unit, and a concentration calculating unit configured to calculate the concentration of the target component in the arbitrary target layer, based on the light absorption coefficient, which has been calculated by the light absorption coefficient calculating unit.

The light absorption coefficient of the arbitrary target layer can be calculated selectively from the time-resolved waveform of the received light. The effect from the noise of other layers can be reduced by calculating the concentration of the target component based on the light absorption coefficient that has been calculated. As a result, the concentration can be quantified with a high accuracy.

The measured light intensity acquisition unit may acquire the light intensities at a plurality of times t₁, . . . , tₘ where the number of the times m is equal to or more than the number of the layers in the observed object n. The light absorption coefficient calculating unit may calculate the light absorption coefficient of the arbitrary target layer from the equation:

$$\{ \begin{matrix}N ( {t}_{1} ) ln ( \frac{N ( {t}_{1} )}{I ( {t}_{1} )} ) = {\sum }_{i = 1}^{n} {μ}_{i} {L}_{i} ( {t}_{1} ) \\ ⋮ \\ N ( {t}_{m} ) ln ( \frac{N ( {t}_{m} )}{I ( {t}_{m} )} ) = {\sum }_{i = 1}^{n} {μ}_{i} {L}_{i} ( {t}_{m} )\end{matrix} \qquad ( 1 )$$

where I(t) is the light intensity of the light received by the light receiving unit at a time t, N(t) is the light intensity of the short-time-pulse of light in the time-resolved waveform model at the time t, Lᵢ(t) is the TPD of the i-th layer in the TPD model at the time t, and μₜ is the light absorption coefficient of the i-th layer.

The plurality of times, when the measured light intensity acquisition unit acquires the light intensities, may include a peak time of the TPD model of each layer of the plurality of layers of light scattering medium.

The measured light intensity acquisition unit may acquire the light intensities for a predetermined time length τ from a predetermined time. The light absorption coefficient calculating unit may calculate the light absorption coefficient of the arbitrary target layer from the equation:

$$\{ \begin{matrix}{\int }_{0}^{τ} ln ( \frac{N ( t )}{I ( t )} ) {L}_{1} ( t ) d t = {\sum }_{i = 1}^{n} {μ}_{i} {\int }_{0}^{τ} {L}_{1} ( t ) {L}_{i} ( t ) d t \\ ⋮ \\ {\int }_{0}^{τ} ln ( \frac{N ( t )}{I ( t )} ) {L}_{n} ( t ) d t = {\sum }_{i = 1}^{n} {μ}_{i} {\int }_{0}^{τ} {L}_{n} ( t ) {L}_{i} ( t ) d t\end{matrix} \qquad ( 2 )$$

where I(t) is the light intensity of the light received by the light receiving unit at a time t, N(t) is the light intensity of the short-time-pulse of light in the time-resolved waveform model at the time t, Lᵢ(t) is the TPD of the i-th layer in the TPD model at the time t, the number of the layers in the observed object n, and μᵢ is the light absorption coefficient of the i-th layer.

Using the equation (2), we can reduce the effect of the errors on the calculated absorption coefficient. The error is included in the measured light intensity and the TPD at each time.

The light irradiating unit may irradiate a plurality of lights that have wavelengths 1, . . . , q. The light absorption coefficient calculating unit may calculate the light absorption coefficients of the arbitrary target layer corresponding to wavelengths of the plurality of lights, which have been irradiated by the light irradiating unit. The concentration calculating unit may calculate the concentration of the target component in the arbitrary target layer from the equation:

$$\{ \begin{matrix}{μ}_{a ( 1 )} - {μ}_{a ( 2 )} = {\sum }_{j = 1}^{p} {g}_{j} ( {ɛ}_{j ( 1 )} - {ɛ}_{j ( 2 )} ) \\ ⋮ \\ {μ}_{a ( q - 1 )} - {μ}_{a ( q )} = {\sum }_{j = 1}^{p} {g}_{j} ( {ɛ}_{j ( q - 1 )} - {ɛ}_{j ( q )} )\end{matrix} \qquad ( 3 )$$

where μₐ(i) is the light absorption coefficient of wavelength i in the a-th layer that is the arbitrary target layer, gⱼ is a mole concentration of the j-th component in the observed object, εⱼ(i) is the mole absorption coefficient of wavelength i of the j-th component, p is the number of components in the observed object, and q is the number of the wavelengths of the plurality of lights that have been irradiated by the light irradiating unit.

The plurality of lights, which have been irradiated by the light irradiating unit, may include a light of the wavelength at which the light absorption coefficient of the target component is higher than other wavelengths.

The plurality of lights, which have been irradiated by the light irradiating unit, may include a light of the wavelength at which an orthogonality of the absorption spectrum of each component in the observed object is higher than other wavelengths.

The TPD model of a short-time-pulse of light in each layer of the plurality of layers of light scattering medium, which has been stored in the TPD storage unit, and the time-resolved waveform model of the short-time-pulse of light, which has been stored in the time-resolved waveform storage unit, may be calculated by performing a simulation regarding the light absorption coefficient of the observed object as zero.

A method of quantifying concentration may use an apparatus for quantifying concentration, which quantifies the concentration of a target component in an arbitrary target layer of the observed object formed of a plurality of layers of light scattering medium. The apparatus for quantifying concentration may include a TPD storage means for storing a TPD model of a short-time-pulse of light, which is irradiated to the observed object and a time-resolved waveform storage means for storing a time-resolved waveform model of the short-time-pulse of light, which is irradiated to the observed object. The method of quantifying concentration may include a light irradiating means for irradiating the short-time-pulse of light to the observed object, a light receiving means for receiving a backscattered light, the short-time-pulse of light being backscattered from the observed object, a measured light intensity acquisition means for acquiring a light intensity of the backscattered light, which has been received by the light receiving means at a predetermined time after the light irradiating means had irradiated the short-time-pulse of light, a TPD acquisition means for acquiring a TPD of each layer of the plurality of layers of light scattering medium at the predetermined time in the TPD model from the TPD storage means, a model light intensity acquisition means for acquiring the light intensity of the short-time-pulse of light at the predetermined time from the time-resolved waveform model of the short-time-pulse of light in the time-resolved waveform storage means, a light absorption coefficient calculating means for calculating a light absorption coefficient of the arbitrary target layer, based on the light intensity, which has been acquired by the measured light intensity acquisition means, the TPD of each layer of the plurality of layers of light scattering medium, which has been acquired by the TPD acquisition means, and the light intensity, which has been acquired by the model light intensity acquisition means, and a concentration calculating means for calculating the concentration of the target component in the arbitrary target layer, based on the light absorption coefficient, which has been calculated by the light absorption coefficient calculating means.

A program for using an apparatus for quantifying concentration may quantify the concentration of a target component in an arbitrary target layer of the observed object formed of a plurality of layers of light scattering medium. The apparatus for quantifying concentration may include a TPD storage means for storing a TPD model of a short-time-pulse of light, which is irradiated to the observed object, and a time-resolved waveform storage means for storing a time-resolved waveform model of the short-time-pulse of light, which is irradiated to the observed object. The program may make the apparatus for quantifying concentration execute functions. The functions may include a light irradiating means for irradiating the short-time-pulse of light to the observed object, a light receiving means for receiving a backscattered light, the short-time-pulse of light being backscattered from the observed object, a measured light intensity acquisition means for acquiring a light intensity of the backscattered light, which has been received by the light receiving means at a predetermined time after the light irradiating means had irradiated the short-time-pulse of light, a TPD acquisition means for acquiring a TPD of each layer of the plurality of layers of light scattering medium at the predetermined time in the TPD model from the TPD storage means, a model light intensity acquisition means for acquiring the light intensity of the short-time-pulse of light at the predetermined time from the time-resolved waveform model of the short-time-pulse of light in the time-resolved waveform storage means, a light absorption coefficient calculating means for calculating a light absorption coefficient of the arbitrary target layer, based on the light intensity, which has been acquired by the measured light intensity acquisition means, the TPD of each layer of the plurality of layers of light scattering medium, which has been acquired by the TPD acquisition means, and the light intensity, which has been acquired by the model light intensity acquisition means, and a concentration calculating means for calculating the concentration of the target component in the arbitrary target layer, based on the light absorption coefficient, which has been calculated by the light absorption coefficient calculating means.

### BRIEF DESCRIPTION OF THE DRAWINGS

FIG. 1 is a schematic block diagram illustrating a construction of an apparatus for quantifying a blood glucose level in accordance with the invention.

FIG. 2 is a graph showing a TPD in each layer, which is calculated by a simulation unit.

FIG. 3 is a graph showing a time-resolved waveform which is calculated by the simulation unit.

FIG. 4 is a graph showing absorption spectra of primary components of a skin.

FIG. 5 is the first flow chart illustrating the operation of the apparatus for quantifying a blood glucose level.

FIG. 6 is the second flow chart illustrating the operation of the apparatus for quantifying a blood glucose level.

### DESCRIPTION OF EXEMPLARY EMBODIMENTS

### First Embodiment

A first embodiment of the invention will be described herein with reference to figures.

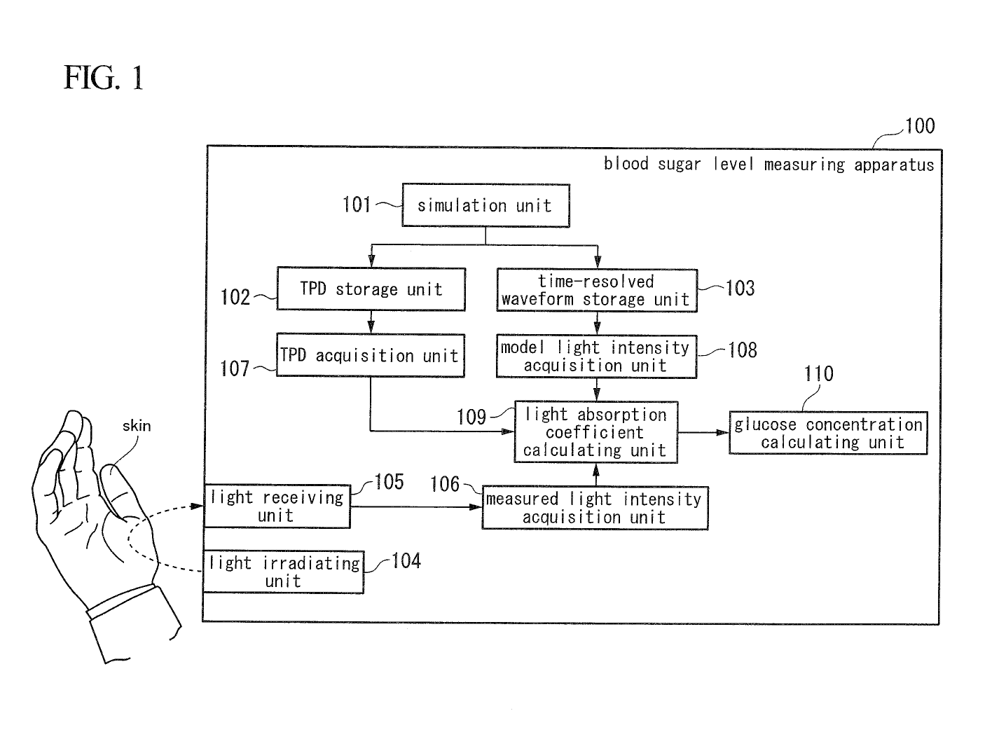

FIG. 1 is a schematic block diagram illustrating a construction of an apparatus for quantifying a blood glucose level in accordance with the first embodiment of the invention.

A blood sugar level measuring apparatus 100 (a concentration quantifying apparatus) includes a simulation unit 101, a TPD storage unit 102 (a TPD storage means), a time-resolved waveform storage unit 103 (a time-resolved waveform storage means), a light irradiating unit 104 (a light irradiating means), a light receiving unit 105 (a light receiving means), a measured light intensity acquisition unit 106 (a measured light intensity acquisition means), a TPD acquisition unit 107 (a TPD acquisition means), a model light intensity acquisition unit 108 (a model light intensity acquisition means), a light absorption coefficient calculating unit 109 (a light absorption coefficient calculating means), and a concentration calculating unit 110 (a concentration calculating means).

The blood sugar level measuring apparatus 100 measures the concentration of glucose (a target component) that is included in a dermis layer (an arbitrary target layer) of a person's skin (an observed object).

The simulation unit 101 performs a simulation of irradiating light onto skin model where the light absorption coefficient is zero.

The TPD storage unit 102 stores a TPD of the skin model where the light absorption coefficient is zero.

The time-resolved waveform storage unit 103 stores a time-resolved waveform of the skin model where the light absorption coefficient is zero.

The light irradiating unit 104 irradiates a short-time-pulse of light onto the skin.

The short-time-pulse of light is backscattered by the skin, and the light receiving unit 105 receives the backscattered light.

The measured light intensity acquisition unit 106 acquires the light intensity of the backscattered light, which has been received by the light receiving unit 105, at a predetermined time.

The TPD acquisition unit 107 acquires the TPD at the predetermined time from the TPD storage unit 102.

The model light intensity acquisition unit 108 acquires the light intensity at the predetermined time from the time-resolved waveform storage unit 103.

The light absorption coefficient calculating unit 109 calculates the light absorption coefficient of the arbitrary target layer of the skin that the short-time-pulse of light is irradiated onto.

The concentration calculating unit 110 calculates the concentration of glucose in the arbitrary target layer.

The light irradiating unit 104 irradiates the short-time-pulse of light onto the skin in the blood sugar level measuring apparatus 100. The short-time-pulse of light is backscattered from the skin, and the light receiving unit 105 receives the backscattered light. The measured light intensity acquisition unit 106 acquires the light intensity of the backscattered light, which has been received by the light receiving unit 105, at a time t. The TPD acquisition unit 107 acquires the TPD of each layer of the plurality of layers of the skin at the time t from the TPD storage unit 102, based on the TPD of the skin model. The model light intensity acquisition unit 108 acquires the light intensity of the short-time-pulse of light in the skin model at the time t from the time-resolved waveform storage unit 103.

Next, the light absorption coefficient calculating unit 109 calculates the light absorption coefficient of the arbitrary target layer of the skin based on the light intensity, which has been acquired by the measured light intensity acquisition unit 106, the TPD of each layer of the skin, which has been acquired by the TPD acquisition unit 107, and the light intensity, which has been acquired by the model light intensity acquisition unit 108. The concentration calculating unit 110 calculates the concentration of glucose in the arbitrary target layer based on the light absorption coefficient calculated by the light absorption coefficient calculating unit 109.

The effect of the noise from other layers than the arbitrary target layer can be reduced, and the concentration of glucose in the arbitrary target layer can be calculated.

Next, operation of the blood sugar level measuring apparatus 100 will be described.

It is necessary to calculate the TPD of each layer and the time-resolved waveform of the skin model, before the blood sugar level is measured by the blood sugar level measuring apparatus 100.

The way of calculating the TPD of each layer and the time-resolved waveform of the skin model will be described.

First, the simulation unit 101 generates the skin model by determining a light scattering coefficient, the light absorption coefficient, and a thickness of each layer of the skin. Individual differences of the light scattering coefficient and the thickness of each layer of the skin are few. It is better to determine the light scattering coefficient and the thickness of each layer of the skin by analyzing samples beforehand. The thickness of the epidermis layer is about 0.3 mm. The thickness of the dermis layer is about 1.2 mm. The thickness of the hypodermis layer is about 3.0 mm.

The light absorption coefficient in the skin model that is used here is zero. This is because a light absorption amount is calculated using the skin model.

After generating the skin model, the simulation unit 101 performs the simulation of light irradiation to the skin. It is necessary to determine the distance between the light irradiating unit 104 and the light receiving unit 105 beforehand. The simulation may be a Monte-Carlo simulation. The Monte-Carlo simulation will be described.

A photon is a model of the light that is irradiated. First, the simulation unit 101 performs the simulation irradiating the photon onto the skin model. The photon irradiated to the skin model moves in the skin model. The distance L and the direction θ of the position where the photon moves next is determined by a random number R. The simulation unit 101 calculates the distance L of the position where the photon moves next based on the equation:

L=ln(R/μₛ) (4)

where ln(A) is a natural logarithm of A, and μₛ is the scattering coefficient of the s-th layer (one of the epidermis layer, the dermis layer, and the hypodermis layer) of the skin model.

The simulation unit 101 calculates the direction θ of the position where the photon moves next based on the equation:

$$θ = {cos}^{- 1} [ \frac{1}{2 g} \{ 1 + {g}^{2} - {( \frac{1 - {g}^{2}}{1 + g - 2 gR} )}^{2} \} ] \qquad ( 5 )$$

where g is an anisotropy parameter that is a mean of cosine of scattering angles. The anisotropy parameter of the skin is about 0.9.

The simulation unit 101 repeats the calculations using the equations (4) and (5) in a unit of time, and can calculate a photon propagation pathway from the light irradiating unit 104 to the light receiving unit 105. The simulation unit 101 calculates the moving distances of a plurality of photons. For example, the simulation unit 101 calculates the moving distances of 100,000,000 photons.

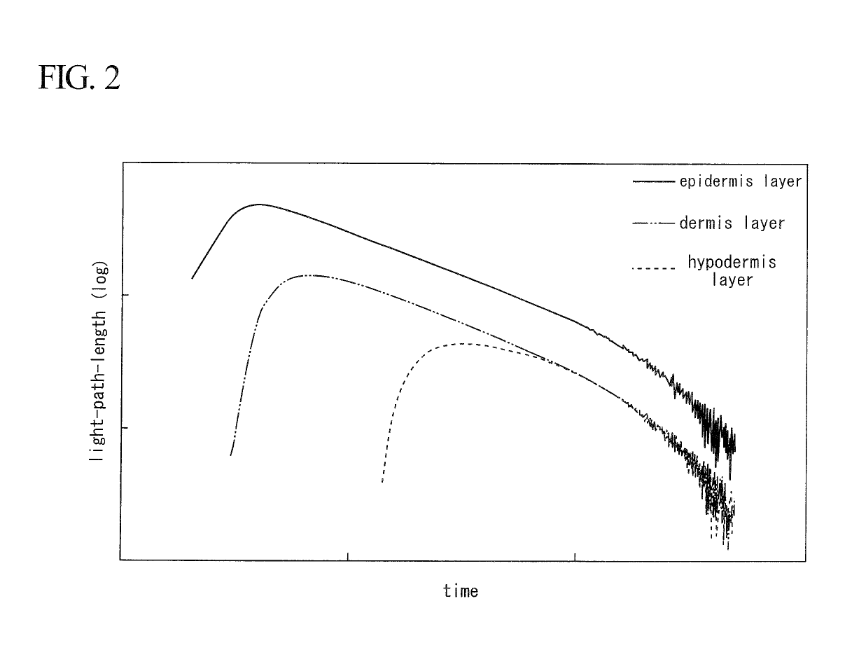

FIG. 2 is a graph showing the TPD in each layer, which is calculated by the simulation unit 101.

The horizontal axis of FIG. 2 represents the time since irradiating the photon. The longitudinal axis of FIG. 2 represents a logarithm of the TPD. The simulation unit 101 classifies the propagation pathway of each photon, which is received by the light receiving unit 105, by layers that the propagation pathway passes through. The simulation unit 101 calculates a mean length of the propagation pathways of the photons, which arrive in a unit of time, in each classified layer. As a result, the TPD of each layer of the skin, as illustrated in FIG. 2, is calculated.

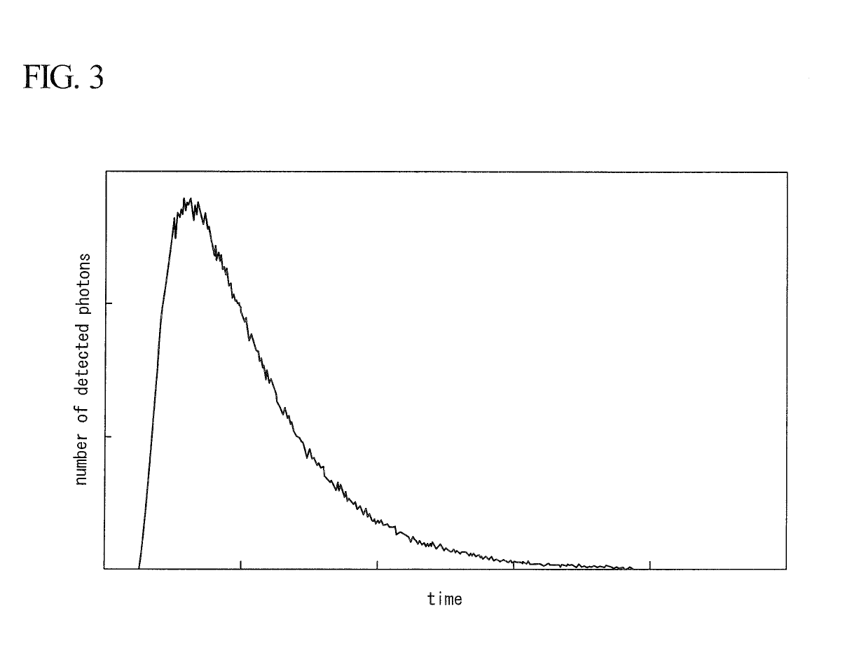

FIG. 3 is a graph showing a time-resolved waveform which is calculated by a simulation unit.

The horizontal axis of FIG. 3 represents the passage time since irradiating of the photon. The longitudinal axis of FIG. 3 represents the number of the photons that the light receiving unit 105 receives. The simulation unit 101 calculates the time-resolved waveform of the skin model, as illustrated in FIG. 3, by acquiring the number of the photons that the light receiving unit 105 receives in a unit of time.

By the above described process, the simulation unit 101 calculates the TPD and the time-resolved waveform of the skin model corresponding to a plurality of wavelengths. The plurality of wavelengths may improve the orthogonality of the absorption spectra of the primary component of the skin, such as water, protein, lipid and glucose. The simulation unit 101 may calculate the TPD and the time-resolved waveform of the skin model corresponding to the plurality of wavelengths.

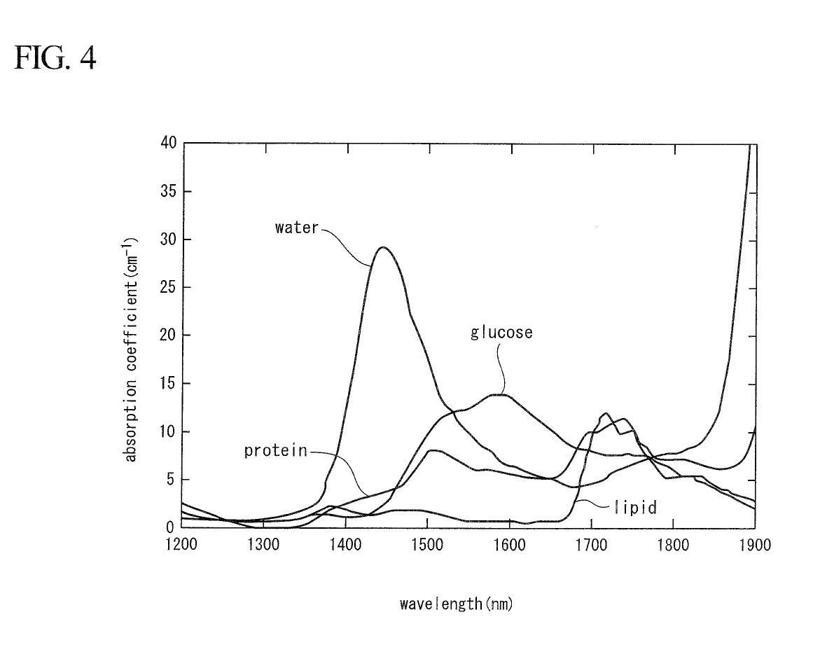

FIG. 4 is a graph showing the absorption spectra of the primary components of the skin.

The horizontal axis of FIG. 4 represents the wavelength of the light that is irradiated. The longitudinal axis of FIG. 4 represents the absorption coefficient. Referring to FIG. 4, the absorption coefficient of glucose is at its maximum value when the wavelength is 1600 nm. The absorption coefficient of water is at its maximum value when the wavelength is 1450 nm. Therefore, the simulation unit 101 may calculate the TPD and the time-resolved waveform when the wavelength is 1450 nm or 1600 nm, which improves the orthogonality of the absorption spectra of the primary components of the skin.

After calculating the TPD and the time-resolved waveform of the skin model corresponding to the plurality of wavelengths, the simulation unit 101 makes the TPD storage unit 102 store information of the TPD, and makes the time-resolved waveform storage unit 103 store information of the time-resolved waveform.

Next, operation of the blood sugar level measuring apparatus 100 measuring the blood sugar level will be described.

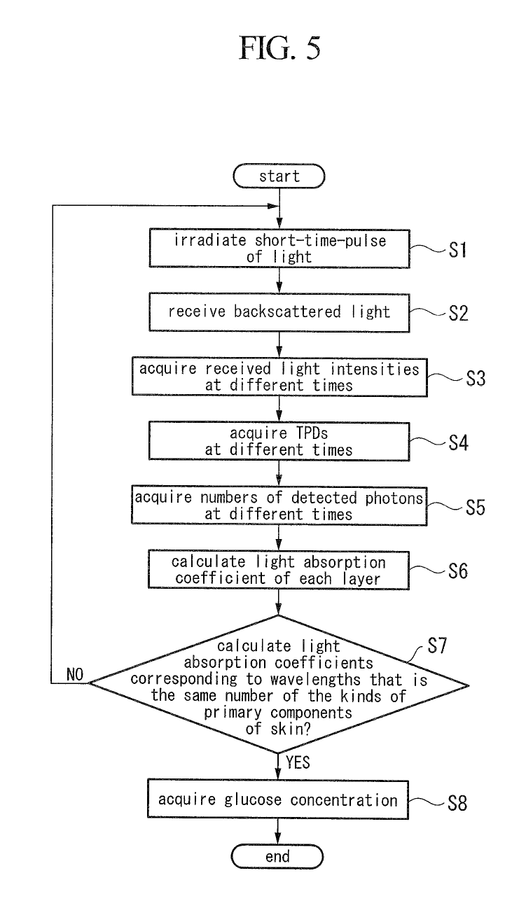

FIG. 5 is the first flow chart illustrating the operation of the blood sugar level measuring apparatus 100 measuring the blood sugar level.

First, the blood sugar level measuring apparatus 100 is pushed against the skin by a user, and the operation of the blood sugar level measuring apparatus 100 is started by pushing a measurement start switch (which is not illustrated in the figure), for example. Then the light irradiating unit 104 irradiates the short-time-pulse of light of wavelength λ₁ to the skin (Step S1). The wavelength λ₁ is one of the plurality of wavelengths of which the simulation unit 101 has calculated the TPD and the time-resolved waveform.

After the light irradiating unit 104 irradiates the short-time-pulse of light, the light receiving unit 105 receives the light that is irradiated by the light irradiating unit 104 and is backscattered from the skin (Step S2). The light receiving unit 105 stores a received light intensity in a unit of time (per 1 picosecond, for example) since the start of the irradiation, in an internal memory.

After the light receiving unit 105 has finished receiving the light, the measured light intensity acquisition unit 106 acquires the received light intensities I(t) at different times t, which is stored in the internal memory of the light receiving unit 105, the number of the received light intensities I(t) at different times being equal to the number of the layers of the skin (Step S3). The measured light intensity acquisition unit 106 acquires the received light intensities I(t₁), I(t₂) and I(t₃) at three different times t₁, t₂ and t₃. The reason why the number of the received light intensities that are acquired is equal to the number of the layers of the skin is that the absorption coefficient of each layer of the skin is calculated based on a simultaneous equation in the process that will be described.

The times t₁, t₂ and t₃ when the measured light intensity acquisition unit 106 acquires the light intensities may be the time when the TPD of each layer of the skin has a peak point. The time may be the time, when the light irradiating unit 104 irradiates the short-time-pulse of light, plus the time, when the TPD of each layer of the skin is at its maximum value in the graph of FIG. 2.

After the measured light intensity acquisition unit 106 acquires the received light intensities I(t₁), I(t₂) and I(t₃), the TPD acquisition unit 107 acquires the TPDs L₁(t₁), L₁(t₂), L₁(t₃), L₂(t₁), L₂(t₂), L₂(t₃), L₃(t₁), L₃(t₂) and L₃(t₃) of each layer of the skin at the times t₁, t₂ and t₃ based on the TPDs of the wavelength λ₁, which were stored in the TPD storage unit 102 (Step S4).

After the measured light intensity acquisition unit 106 acquires the received light intensities I(t₁), I(t₂) and I(t₃), the model light intensity acquisition unit 108 acquires detected-photon-numbers N(t₁), N(t₂) and N(t₃) at the times t₁, t₂ and t₃ based on the time-resolved waveform of the wavelength λ₁, which was stored in the time-resolved waveform storage unit 103 (Step S5).

After the TPD acquisition unit 107 acquires the TPD of each layer of the skin and the model light intensity acquisition unit 108 acquires the detected-photon-number, the light absorption coefficient calculating unit 109 calculates the light absorption coefficients μ₁, μ₂ and μ₃ of each layer of the skin based on the equation (6) (Step S6). Here, the light absorption coefficient μ₁ represents the light absorption coefficient of the epidermis layer. The light absorption coefficient μ₂ represents the light absorption coefficient of the dermis layer. The light absorption coefficient μ₃ represents the light absorption coefficient of the hypodermis layer.

$$\{ \begin{matrix}{N}^{′} ( {t}_{1} ) ln ( \frac{{N}^{′} ( {t}_{1} )}{{I}^{′} ( {t}_{1} )} ) = {\sum }_{i = 1}^{3} {μ}_{i} {L}_{i} ( {t}_{1} ) \\ {N}^{′} ( {t}_{2} ) ln ( \frac{{N}^{′} ( {t}_{2} )}{{I}^{′} ( {t}_{2} )} ) = {\sum }_{i = 1}^{3} {μ}_{i} {L}_{i} ( {t}_{2} ) \\ {N}^{′} ( {t}_{3} ) ln ( \frac{{N}^{′} ( {t}_{3} )}{{I}^{′} ( {t}_{3} )} ) = {\sum }_{i = 1}^{3} {μ}_{i} {L}_{i} ( {t}_{3} )\end{matrix} \\ Where {N}^{′} ( t ) = \frac{N ( t )}{{N}_{i n}} , {I}^{′} ( t ) = \frac{I ( t )}{{I}_{i n}} \qquad ( 6 )$$

Here, ln(A) is a natural logarithm of A. Iᵢₙ is the light intensity of the short-time-pulse of light that is irradiated by the light irradiating unit 104. Nᵢₙ is the number of the photons that the simulation unit 101 uses in the simulation of irradiating the photons.

After the light absorption coefficient calculating unit 109 calculates the light absorption coefficients μ₁, μ₂ and μ₃ of each layer of the skin, the light absorption coefficient calculating unit 109 determines whether or not all the light absorption coefficients μ₁, μ₂ and μ₃ are calculated corresponding to the wavelengths, the number of the wavelengths being equal to the number of the types of primary components of the skin (Step S7). In the first embodiment, the blood sugar level is measured using four types of primary components i.e., the skin, water, protein, lipid and glucose. Therefore, the light absorption coefficient calculating unit 109 determines whether or not the light absorption coefficients μ₁, μ₂ and μ₃ are calculated corresponding to four wavelengths λ₁, λ², λ² and λ₄. The wavelengths λ₁, λ₂, λ₃ and λ₄ are selected from the plurality of wavelengths, of which the TPD and the time-resolved waveform have been calculated by the simulation unit 101.

If the light absorption coefficient calculating unit 109 determines that the light absorption coefficients μ₁, μ₂ and μ₃ are not calculated for all the wavelengths λ₁, λ², λ₃ and λ₄ (“No” in Step S7), the flow of the process returns to Step S1. Then the light absorption coefficients μ₁, μ₂ and μ₃ for all the wavelengths λ₁, λ₂, λ₃ and λ₄, of which the light absorption coefficients μ₁, μ₂ and μ₃ have not been calculated, are calculated.

On the other hand, if the light absorption coefficient calculating unit 109 determines that the light absorption coefficients μ₁, μ₂ and μ₃ of the wavelengths λ₁, λ₂, λ₃ and λ₄ are calculated (“Yes” in Step S7), then the glucose concentration calculating unit 110 calculates the concentration of glucose included in the dermis layer based on the equation (7) (Step S8).

$$\{ \begin{matrix}{μ}_{2 ( 1 )} - {μ}_{2 ( 2 )} = {\sum }_{i = 1}^{4} {g}_{i} ( {ɛ}_{i ( 1 )} - {ɛ}_{i ( 2 )} ) \\ ⋮ \\ {μ}_{2 ( 4 )} - {μ}_{2 ( 1 )} = {\sum }_{i = 1}^{4} {g}_{i} ( {ɛ}_{i ( 4 )} - {ɛ}_{i ( 1 )} )\end{matrix} \qquad ( 7 )$$

Here, μ₂(1), μ₂(2), μ₂(3) and μ₂(4) are the light absorption coefficients of the wavelengths λ₁, λ₂, λ₃ and λ₄ in the dermis layer. g₁, g₂, g₃ and g₄ are mole concentrations of water, protein, lipid and glucose that are the primary components of the skin in the dermis layer. ε₁(1), ε₁(2), ε₁(3) and ε₁(4) are the mole absorption coefficients of water corresponding to the wavelengths λ₁, λ₂, λ₃ and λ₄. ε₂(1), ε₂(2), ε₂(3) and ε₂(4) are the mole absorption coefficients of protein corresponding to the wavelengths λ₁, λ₂, λ₃ and λ₄. ε₃(1), ε₃(2), ε₃(3) and ε₃(4) are the mole absorption coefficients of lipid corresponding to the wavelengths λ₁, λ₂, λ₃ and λ₄. ε₄(1), ε₄(2), ε₄(3) and ε₄(4) are the mole absorption coefficients of glucose corresponding to the wavelengths λ₁, λ₂, λ₃ and λ₄. The mole concentration of glucose included in the dermis layer can be acquired by calculating g₄ based on the equation (7).

The theory of acquiring the mole concentration of glucose based on the equation (7) will be described. The wavelength dependence of the scattering coefficient of the skin is small. The variations to the wavelength of the detected-photon-numbers N(t) and the TPD Lₙ(t) are negligibly small. According to the Beer-Lambert law, the light absorption amount equals the product of the mole absorption coefficient and the mole concentration. The equation (7), which shows a relationship between the difference of the absorption coefficients in the dermis layer and the mole absorption coefficient of each skin component, is acquired by the time-resolved measurement using two wavelengths, deleting the detected-photon-number N(t).

As described above, in the first embodiment, the concentration of glucose is quantified by irradiating the short-time-pulse of light, based on the light intensity of the light that is received at the predetermined time. As a result, the absorption coefficient of the dermis layer can be calculated selectively from the light that is received at the predetermined time. Therefore, the concentration of glucose in the specific layer of the skin can be calculated, and the blood sugar level can be calculated in a high accuracy, reducing the effect of noises from other layers.

### Second Embodiment

A second embodiment of the invention will be described.

The blood sugar level measuring apparatus 100 in accordance with the second embodiment has the same construction as the blood sugar level measuring apparatus 100 in accordance with the first embodiment. Operations of the measured light intensity acquisition unit 106, the TPD acquisition unit 107, the model light intensity acquisition unit 108, and the light absorption coefficient calculating unit 109 in accordance with the second embodiment are different from the first embodiment.

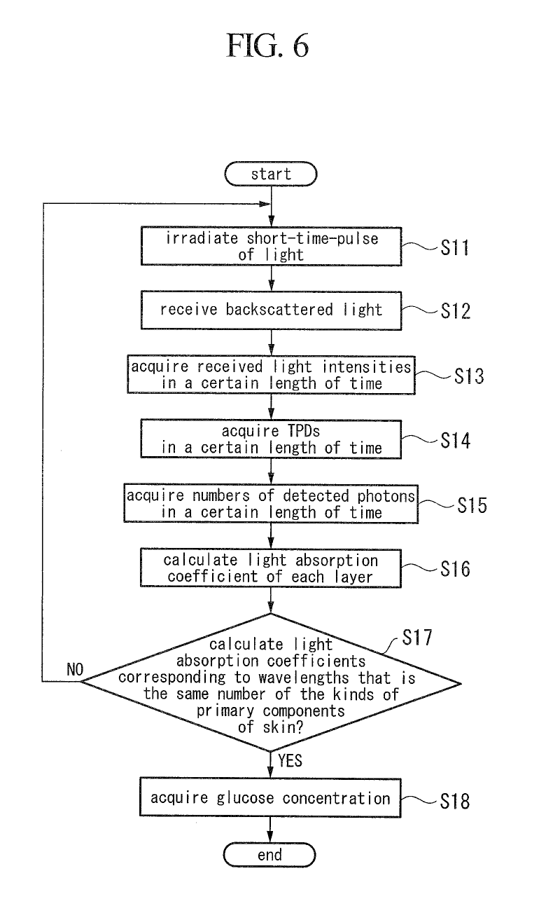

FIG. 6 is a second flow chart illustrating the operation of the blood sugar level measuring apparatus 100 to measure the blood sugar level.

When the blood sugar level measuring apparatus 100 is operated, the light irradiating unit 104 irradiates the short-time-pulse of light of wavelength λ₁ to the skin (Step S11). The wavelength λ₁ is one of the plurality of wavelengths of which the simulation unit 101 has calculated the TPD and the time-resolved waveform.

After the light irradiating unit 104 irradiates the short-time-pulse of light, the light receiving unit 105 receives the light that is irradiated by the light irradiating unit 104 and is backscattered from the skin (Step S12). The light receiving unit 105 stores a received light intensity in a unit of time (per 1 picosecond, for example) since the start of the irradiation, in an internal memory.

After the light receiving unit 105 has finished receiving the light, the measured light intensity acquisition unit 106 acquires a temporal distribution of the received light intensities for a time interval τ since a predetermined time, which is stored in the internal memory of the light receiving unit 105 (Step S13).

After the measured light intensity acquisition unit 106 acquires the temporal distribution of the received light intensities for the time interval τ, the TPD acquisition unit 107 acquires the TPDs L₁, L₂ and L₃ of each layer of the skin for the time interval τ since the predetermined time based on the TPDs of the wavelength λ₁, which were stored in the TPD storage unit 102 (Step S14).

After the measured light intensity acquisition unit 106 acquires the received light intensities for the time interval τ, the model light intensity acquisition unit 108 acquires detected-photon-numbers for the time interval τ since the predetermined time based on the time-resolved waveform of the wavelength λ₁, which was stored in the time-resolved waveform storage unit 103 (Step S15).

After the TPD acquisition unit 107 acquires the TPD of each layer of the skin and the model light intensity acquisition unit 108 acquires the detected-photon-number, the light absorption coefficient calculating unit 109 calculates the light absorption coefficients μ₁, μ₂ and μ₃ of each layer of the skin based on the equation (6) (Step S16). Here, the light absorption coefficient μ₁ represents the light absorption coefficient of the epidermis layer. The light absorption coefficient μ₂ represents the light absorption coefficient of the dermis layer. The light absorption coefficient μ₃ represents the light absorption coefficient of the hypodermis layer.

$$\{ \begin{matrix}{\int }_{0}^{τ} ln ( \frac{{N}^{′} ( t )}{{I}^{′} ( t )} ) {L}_{1} ( t ) d t = {\sum }_{i = 1}^{3} {μ}_{i} {\int }_{0}^{τ} {L}_{1} ( t ) {L}_{i} ( t ) d t \\ \begin{matrix}{\int }_{0}^{τ} ln ( \frac{{N}^{′} ( t )}{{I}^{′} ( t )} ) {L}_{2} ( t ) d t = {\sum }_{i = 1}^{3} {μ}_{i} {\int }_{0}^{τ} {L}_{2} ( t ) {L}_{i} ( t ) d t \\ {\int }_{0}^{τ} ln ( \frac{{N}^{′} ( t )}{{I}^{′} ( t )} ) {L}_{3} ( t ) d t = {\sum }_{i = 1}^{3} {μ}_{i} {\int }_{0}^{τ} {L}_{3} ( t ) {L}_{i} ( t ) d t\end{matrix}\end{matrix} \\ Where {N}^{′} ( t ) = \frac{N ( t )}{{N}_{i n}} , {I}^{′} ( t ) = \frac{I ( t )}{{I}_{i n}} \qquad ( 8 )$$

Here, ln(A) is a natural logarithm of A. I(t) is the received light intensity of the light receiving unit 105 at the time t. Iᵢₙ is the light intensity of the short-time-pulse of light that is irradiated by the light irradiating unit 104. N(t) is the detected-photon-number of the time-resolved waveform at the time t. Nᵢₙ is the number of the photons that the simulation unit 101 uses in the simulation of irradiating the photons. L₁(t), L₂(t) and L₃(t) are the TPDs of each layer of the skin at the time t.

After the light absorption coefficient calculating unit 109 calculated the light absorption coefficients μ₁, μ₂ and μ₃ of each layer of the skin, the light absorption coefficient calculating unit 109 determines whether or not all the light absorption coefficients μ₁, μ₂ and μ₃ are calculated corresponding to the wavelengths, the number of the wavelengths being equal to the number of the types of primary components of the skin (Step S17). In the second embodiment, the blood sugar level is measured using four types of primary components i.e., the skin, water, protein, lipid and glucose. Therefore, the light absorption coefficient calculating unit 109 determines whether or not the light absorption coefficients μ₁, μ₂ and μ₃ are calculated corresponding to four wavelengths λ₁, λ₂, λ₃ and λ₄. The wavelengths λ₁, λ₂, λ₃ and λ₄ are selected from the plurality of wavelengths, of which the TPD and the time-resolved waveform have been calculated by the simulation unit 101.

If the light absorption coefficient calculating unit 109 determines that the light absorption coefficients μ₁, μ₂ and μ₃ are not calculated for all the wavelengths λ₁, λ₂, λ₃ and λ₄ (“No” in Step S17), then the flow of the process returns to Step S11. Then the light absorption coefficients μ₁, μ₂ and μ₃ of the wavelengths λ₁, λ₂, λ₃ and λ₄, of which the light absorption coefficients μ₁, μ₂ and μ₃ have not been calculated, are calculated.

On the other hand, if the light absorption coefficient calculating unit 109 determines that the light absorption coefficients μ₁, μ₂ and μ₃ for all the wavelengths λ₁, λ₂, λ₃ and λ₄ are calculated (“Yes” in Step S17), then the glucose concentration calculating unit 110 calculates the concentration of glucose included in the dermis layer based on the equation (7) (Step S18).

As described above, in the second embodiment, the absorption coefficients μ₁, μ₂ and μ₃ are calculated based on an integral value of the TPD for the time interval τ. As a result, the effect of the error in the measured light intensities I(t) on the calculation of the absorption coefficients μ₁, μ₂ and μ₃ can be reduced.

While embodiments of the invention have been described using figures, the specific construction is not limited to the above description. Various modifications such as design changes can be made without departing from the scope of the invention.

For example, in the first and second embodiments, the concentration qualifying method was applied to the blood sugar level measuring apparatus 100, and the blood sugar level measuring apparatus 100 measured the concentration of glucose included in the dermis layer of the skin. But the concentration qualifying method is not limited to these, and may be applied to other apparatuses that qualify the concentration of the target component in the arbitrary target layer of the observed object with layers of light scattering medium.

The blood sugar level measuring apparatus 100 includes a computer system inside. Operation of each processing unit described above is stored in the storage medium that can be read by the computer in the format of the program. The above described process is performed by the computer reading the program and executing the program. Here, the storage medium that can be read by the computer may be a magnetic disc, a magnetooptical disc, a CD-ROM, a DVD-ROM, a semiconductor memory, etc. The computer program may be delivered to the computer through a communication line and the computer that received the delivered program may execute the program.

The above program may realize a part of the above described functions. The program may be a difference file (a difference program) that realizes the function by combined with the stored program in the computer system.

While preferred embodiments of the invention have been described and illustrated above, it should be understood that these are examples of the invention and are not to be considered as limiting. Additions, omissions, substitutions, and other modifications can be made without departing from the scope of the invention. Accordingly, the invention is not to be considered as being limited by the foregoing description, and is only limited by the scope of the appended claims.

What is claimed is:

1. An apparatus for quantifying concentration that quantifies the concentration of a target component in an arbitrary target layer, which is in an observed object formed of a plurality of layers of light scattering medium, the apparatus comprising:
a TPD storage unit configured to store a TPD model of a short-time-pulse of light in each layer of the plurality of layers of light scattering medium, the short-time-pulse of light being irradiated to the observed object;
a time-resolved waveform storage unit configured to store a time-resolved waveform model of the short-time-pulse of light that is irradiated to the observed object;
a light irradiating unit configured to irradiate the short-time-pulse of light to the observed object;
a light receiving unit configured to receive a backscattered light, the short-time-pulse of light being backscattered from the observed object;
a measured light intensity acquisition unit configured to acquire a light intensity of the backscattered light that has been received by the light receiving unit at a predetermined time after the light irradiating unit had irradiated the short-time-pulse of light;
a TPD acquisition unit configured to acquire a TPD of each layer of the plurality of layers of light scattering medium at the predetermined time from the TPD model that has been stored by the TPD storage unit;
a model light intensity acquisition unit configured to acquire the light intensity of the short-time-pulse of light at the predetermined time from the time-resolved waveform model of the short-time-pulse of light that has been stored by the time-resolved waveform storage unit;
a light absorption coefficient calculating unit configured to calculate a light absorption coefficient of the arbitrary target layer, based on the light intensity that has been acquired by the measured light intensity acquisition unit, the TPD of each layer of the plurality of layers of light scattering medium that has been acquired by the TPD acquisition unit, and the light intensity that has been acquired by the model light intensity acquisition unit; and
a concentration calculating unit configured to calculate the concentration of the target component in the arbitrary target layer, based on the light absorption coefficient that has been calculated by the light absorption coefficient calculating unit.

2. The apparatus for quantifying concentration according to claim 1,
the measured light intensity acquisition unit acquiring the light intensities at a plurality of times t₁, . . . , tₘ where the number of the times m is equal to or more than the number of the layers in the observed object n,
the light absorption coefficient calculating unit calculating the light absorption coefficient of the arbitrary target layer based on the equation:
$$\{ \begin{matrix}N ( {t}_{1} ) ln ( \frac{N ( {t}_{1} )}{I ( {t}_{1} )} ) = {\sum }_{i = 1}^{n} {μ}_{i} {L}_{i} ( {t}_{1} ) \\ ⋮ \\ N ( {t}_{m} ) ln ( \frac{N ( {t}_{m} )}{I ( {t}_{m} )} ) = {\sum }_{i = 1}^{n} {μ}_{i} {L}_{i} ( {t}_{m} )\end{matrix}$$
where I(t) is the light intensity of the light received by the light receiving unit at a time t, N(t) is the light intensity of the short-time-pulse of light in the time-resolved waveform model at the time t, Lᵢ(t) is the TPD of an i-th layer in the TPD model at the time t, and μᵢ is the light absorption coefficient of the i-th layer.

3. The apparatus for quantifying concentration according to claim 2, the plurality of times including a peak time of the TPD model of each layer of the plurality of layers of light scattering medium when the measured light intensity acquisition unit acquires the light intensities.

4. The apparatus for quantifying concentration according to claim 1,
the measured light intensity acquisition unit acquiring the light intensities for at least a predetermined time length τ since a predetermined time,
the light absorption coefficient calculating unit calculating the light absorption coefficient of the arbitrary target layer based on the equation:
$$\{ \begin{matrix}{\int }_{0}^{τ} ln ( \frac{N ( t )}{I ( t )} ) {L}_{1} ( t ) d t = {\sum }_{i = 1}^{n} {μ}_{i} {\int }_{0}^{τ} {L}_{1} ( t ) {L}_{i} ( t ) d t \\ ⋮ \\ {\int }_{0}^{τ} ln ( \frac{N ( t )}{I ( t )} ) {L}_{n} ( t ) d t = {\sum }_{i = 1}^{n} {μ}_{i} {\int }_{0}^{τ} {L}_{n} ( t ) {L}_{i} ( t ) d t\end{matrix} \qquad$$
where I(t) is the light intensity of the light received by the light receiving unit at a time t, N(t) is the light intensity of the short-time-pulse of light in the time-resolved waveform model at the time t, Lᵢ(t) is the TPD of an i-th layer in the TPD model at the time t, n is the number of the layers in the observed object, and μᵢ is the light absorption coefficient of the i-th layer.

5. The apparatus for quantifying concentration according to claim 1,
the light irradiating unit irradiating a plurality of lights that have wavelengths 1, . . . , q,
the light absorption coefficient calculating unit calculating the light absorption coefficients of the arbitrary target layer corresponding to wavelengths of the plurality of lights that have been irradiated by the light irradiating unit, and
the concentration calculating unit calculating the concentration of the target component in the arbitrary target layer based on the equation:
$$\{ \begin{matrix}{μ}_{a ( 1 )} - {μ}_{a ( 2 )} = {\sum }_{j = 1}^{p} {g}_{j} ( {ɛ}_{j ( 1 )} - {ɛ}_{j ( 2 )} ) \\ ⋮ \\ {μ}_{a ( q - 1 )} - {μ}_{a ( q )} = {\sum }_{j = 1}^{p} {g}_{j} ( {ɛ}_{j ( q - 1 )} - {ɛ}_{j ( q )} )\end{matrix} \qquad$$
where μₐ(i) is the light absorption coefficient of wavelength i in the a-th layer that is the arbitrary target layer, gⱼ is a mole concentration of the j-th component in the observed object, εⱼ(i) is the mole absorption coefficient of wavelength i of the j-th component, p is the number of components in the observed object, and q is the number of the wavelengths of the plurality of lights that have been irradiated by the light irradiating unit.

6. The apparatus for quantifying concentration according to claim 5,
the plurality of lights that have been irradiated by the light irradiating unit including the light with the wavelength, at which the light absorption coefficient of the target component is high.

7. The apparatus for quantifying concentration according to claim 5,
the plurality of lights that have been irradiated by the light irradiating unit including the lights with wavelengths, at which the orthogonality of absorption spectra is high each other among the primary components that form the observed object.

8. The apparatus for quantifying concentration according to claim 1,
the TPD model of a short-time-pulse of light in each layer of the plurality of layers of light scattering medium that has been stored by the TPD storage unit and the time-resolved waveform model of the short-time-pulse of light that has been stored by the time-resolved waveform storage unit are calculated by performing a simulation regarding the light absorption coefficient of the observed object as zero.

9. A method of quantifying concentration using an apparatus for quantifying concentration that quantifies the concentration of a target component in an arbitrary target layer, which is in an observed object formed of a plurality of layers of light scattering medium,
the apparatus for quantifying concentration comprising:
a TPD storage means that stores a TPD model of a short-time-pulse of light in each layer of the plurality of layers of light scattering medium, the short-time-pulse of light being irradiated to the observed object; and
a time-resolved waveform storage means that stores a time-resolved waveform model of the short-time-pulse of light that is irradiated to the observed object,
the method of quantifying concentration comprising:
a light irradiating means for that irradiates the short-time-pulse of light to the observed object;
a light receiving means that receives a backscattered light, the short-time-pulse of light being backscattered from the observed object;
a measured light intensity acquisition means that acquires a light intensity of the backscattered light that has been received by the light receiving means at a predetermined time after the light irradiating means had irradiated the short-time-pulse of light;
a TPD acquisition means that acquires a TPD of each layer of the plurality of layers of light scattering medium at the predetermined time from the TPD model that has been stored by the TPD storage means;
a model light intensity acquisition means that acquires the light intensity of the short-time-pulse of light at the predetermined time from the time-resolved waveform model of the short-time-pulse of light that has been stored by the time-resolved waveform storage means;
a light absorption coefficient calculating means that calculates a light absorption coefficient of the arbitrary target layer, based on the light intensity that has been acquired by the measured light intensity acquisition means, the TPD of each layer of the plurality of layers of light scattering medium that has been acquired by the TPD acquisition means, and the light intensity that has been acquired by the model light intensity acquisition means; and
a concentration calculating means that calculates the concentration of the target component in the arbitrary target layer, based on the light absorption coefficient that has been calculated by the light absorption coefficient calculating means.

10. A program that uses an apparatus for quantifying concentration that quantifies the concentration of a target component in an arbitrary target layer, the arbitrary target layer being an observed object formed of a plurality of layers of light scattering medium,
the apparatus for quantifying concentration comprising:
a TPD storage means that stores a TPD model of a short-time-pulse of light in each layer of the plurality of layers of light scattering medium, the short-time-pulse of light being irradiated to the observed object; and
a time-resolved waveform storage means that stores a time-resolved waveform model of the short-time-pulse of light that is irradiated to the observed object, and
the program makes the apparatus for quantifying concentration execute functions, the functions comprising:
a light irradiating means that irradiates the short-time-pulse of light to the observed object;
a light receiving means that receives a backscattered light, the short-time-pulse of light being backscattered from the observed object;
a measured light intensity acquisition means that acquires a light intensity of the backscattered light that has been received by the light receiving means at a predetermined time after the light irradiating means had irradiated the short-time-pulse of light;
a TPD acquisition means for acquiring a TPD of each layer of the plurality of layers of light scattering medium at the predetermined time from the TPD model that has been stored by the TPD storage means;
a model light intensity acquisition means that acquires the light intensity of the short-time-pulse of light at the predetermined time from the time-resolved waveform model of the short-time-pulse of light that has been store by the time-resolved waveform storage means;
a light absorption coefficient calculating means that calculates a light absorption coefficient of the arbitrary target layer, based on the light intensity that has been acquired by the measured light intensity acquisition means, the TPD of each layer of the plurality of layers of light scattering medium that has been acquired by the TPD acquisition means, and the light intensity that has been acquired by the model light intensity acquisition means; and
a concentration calculating means that calculates the concentration of the target component in the arbitrary target layer, based on the light absorption coefficient that has been calculated by the light absorption coefficient calculating means.
